(19) United States
(12) Patent Application Publication
(10) Pub. No.: US 2026/0219981 A1
(43) Pub. Date: Jul. 30, 2026

(54) RECORDING MEDIUM, INFORMATION PROCESSING DEVICE, AND INFORMATION PROCESSING SYSTEM

(71) Applicant: 1FINITY Inc., Kawasaki-shi (JP)

(72) Inventor: Kousuke IEMURA, Kawasaki (JP)

(73) Assignee: 1FINITY Inc., Kawasaki-shi (JP)

(21) Appl. No.: 19/417,389

(22) Filed: Dec. 12, 2025

(30) Foreign Application Priority Data
Jan. 27, 2025 (JP) 2025-011457

(51) Int. Cl. G06F 11/07

(52) U.S. Cl. CPC G06F 11/079; G06F 11/0721

(57) ABSTRACT

An information processing device uses an agent including the training model and identifies a first command group corresponding to a first objective corresponding to a first input content. The information processing device uses the agent to generate and execute at least one command of the first command group until the first objective is achieved and repeats a first process of summarizing a result of executing the command. Here, for example, the information processing device generates a command based on at least any of the first input content, a history of executed commands in the first process up to the previous time, and a summary of a result of executing one or more commands. The information processing device uses the agent and when the first objective 102 is achieved, generates answer content corresponding to the first input content.

### CROSS-REFERENCE TO RELATED APPLICATION

This application is based upon and claims the benefit of priority of the prior Japanese Patent Application No. 2025-011457, filed on Jan. 27, 2025, the entire contents of which are incorporated herein by reference.

### FIELD

The embodiments discussed herein are related to a recording medium, an information processing device, and an information processing system.

### BACKGROUND

Conventionally, it is desirable to investigate the cause of a failure that has occurred in a system. For example, in a case where the system includes multiple components, the cause of the failure may be investigated by grasping the state of the system by combining results of executing each of multiple commands.

As for a related art, for example, there is a technique of determining the usefulness of failure-identifying-information corresponding to input failure-input-information, based on failure-identifying characteristic information indicating a characteristic of failure-identifying-information for identifying a failure. Further, for example, there is a technique of executing a command for collecting materials corresponding to an extracted failure pattern when a failure occurs in a computer. For example, refer to Japanese Laid-Open Patent Publication No. 2015-064643 and Japanese Laid-Open Patent Publication No. 2011-118695.

### SUMMARY

According to an aspect of an embodiment, a computer-readable recording medium has stored therein a program for causing a computer to execute a process, the process including: using an agent that includes a training model and determining a first objective corresponding to a first input content; identifying among a plurality of commands, a first command group corresponding to the determined first objective; using the agent and repeatedly performing a first process of generating and executing at least one command of the identified first command group and summarizing a result of executing the generated at least one command until determining that the first objective is achieved; and using the agent and when determining that the determined first objective is achieved, generating and outputting an answer content corresponding to the first input content, based on a summary of a result of executing each of one or more commands already executed in the first process. The repeatedly performing the first process includes generating the at least one command of the first command group, based on at least one of the first input content, a history of the one or more commands that have been executed in the first process, and the summary of the result of executing the generated at least one command of the first command group.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is an explanatory diagram depicting an example of an information processing method according to an embodiment.

FIG. 2 is an explanatory diagram depicting an example of an information processing system 200.

FIG. 3 is a block diagram of an example of a hardware configuration of an information processing device 100.

FIG. 4 is a block diagram depicting an example of a functional configuration of the information processing device 100.

FIG. 5 is an explanatory diagram depicting an example of operation of the information processing device 100.

FIG. 6 is an explanatory diagram depicting an example of the operation of the information processing device 100.

FIG. 7 is an explanatory diagram depicting an example of the operation of the information processing device 100.

FIG. 8 is an explanatory diagram depicting an example of the operation of the information processing device 100.

FIG. 9 is an explanatory diagram depicting an example of the operation of the information processing device 100.

FIG. 10 is an explanatory diagram depicting a specific example of the operation of the information processing device 100.

FIG. 11 is an explanatory diagram depicting a specific example of the operation of the information processing device 100.

FIG. 12 is an explanatory diagram depicting a specific example of the operation of the information processing device 100.

FIG. 13 is an explanatory diagram depicting a specific example of the operation of the information processing device 100.

FIG. 14 is an explanatory diagram depicting a specific example of the operation of the information processing device 100.

FIG. 15 is an explanatory diagram depicting a specific example of the operation of the information processing device 100.

FIG. 16 is a flowchart depicting an example of the overall process procedure.

### DESCRIPTION OF EMBODIMENTS

First, problems associated with the conventional techniques are discussed. In the related art, there is a problem in that it is difficult to investigate the cause of a failure. For example, in order to investigate the cause of a failure that has occurred in a complex system including many components, it is difficult to determine which command is to be preferably executed, and it may be difficult to investigate the cause of the failure that has occurred in the system.

Embodiments of a recording medium, an information processing device, and an information processing system according to the present disclosure are described below in detail with reference to the accompanying drawings.

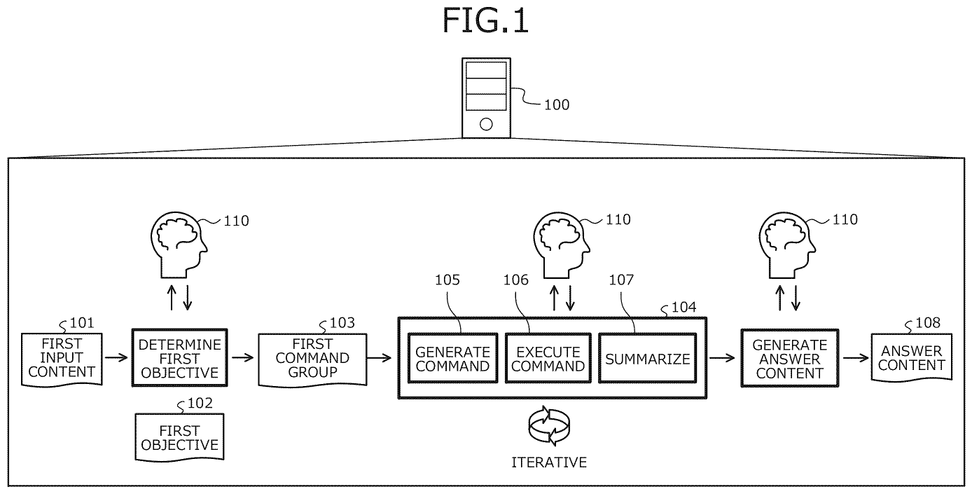

FIG. 1 is an explanatory diagram depicting an example of an information processing method according to an embodiment. The information processing device 100 is a computer for facilitating investigation of the cause of a failure that has occurred in a system. The information processing device 100 is, for example, a server or a personal computer (PC). The system is, for example, a virtualized platform.

Conventionally, as networks become more complicated due to virtualization and software implementation, it is desirable to quickly cope with a failure occurring in a system. For example, it is desirable to investigate the cause of a failure that has occurred in a system. For example, it is conceivable to investigate the cause of a failure that has occurred in a complex system including many components by grasping the state of the system by combining the results of executing multiple commands.

However, in the related art, there is a problem in that it is difficult to investigate the cause of the failure. For example, in order to investigate the cause of a failure that has occurred in a complex system including many components, it is difficult to determine which commands are to be preferably executed and in which order and thus, it is difficult to investigate the cause of the failure that has occurred in the system.

Further, for example, as the number of commands to be executed increases, it tends to become more difficult to appropriately extract information useful for the objective of investigating the cause of a failure that has occurred in the system from a log obtained as a result of executing each command, and to thus investigate the cause of the failure that has occurred in the system.

Further, for example, in a case where the number of executable commands for investigation is enormous, when all the commands are tried, the cost for investigating the cause of the failure increases. The cost is, for example, the processing load or processing time of a computer. The cost may be, for example, the work burden or a work time of a worker who investigates the cause of the failure. In addition, for example, it is considered that a command which is not preferable in terms of security to be executed for investigation is executed. In addition, for example, it is considered that a command which is not preferable in terms of system safety to be executed for investigation is executed.

Therefore, even when the number of executable commands for investigation is enormous, it is desirable to sequentially generate and execute commands to be executed for investigation appropriately and dynamically according to the state of the system. In addition, it is desirable to appropriately extract information useful for the objective of investigating the cause of a failure that has occurred in the system from a log obtained as a result of executing each of multiple commands.

In addition, it is desirable not to execute a command that is not desirable in terms of security to be executed for investigation unless execution thereof is useful for the objective of investigating the cause of a failure. In addition, it is desirable not to execute a command, which is undesirable for the safety of the system to execute for investigation, unless execution thereof is useful for the objective of investigating the cause of a failure.

Thus, in the present embodiment, an information processing method capable of easily investigating the cause of a failure occurring in a system will be described.

In FIG. 1, the information processing device 100 may use an agent 110 including a training model. The training model is, for example, a large-scale language model. The agent 110 is, for example, a software entity that operates to achieve a specific objective. The agent 110 is provided, for example, in the information processing device 100. The agent 110 may be provided external to the information processing device 100, for example.

(1-1) The information processing device 100 determines a first objective 102 corresponding to first input content 101 using the agent 110. The first input content 101 represents, for example, a question content related to a failure that has occurred in the system. The first objective 102 is, for example, an investigation or control objective. The investigation objective means, for example, investigating a failure that has occurred in the system. The control objective means, for example, investigating a failure that has occurred in a system and controlling the system in which the failure has occurred.

For example, the information processing device 100 generates a first prompt that includes the first input content 101 and requests to determine the first objective 102. The information processing device 100 uses the agent 110 and determines the first objective 102, for example, by inputting the generated first prompt to the agent 110. Thus, the information processing device 100 may determine the first objective 102 and obtain a guideline for determining what command is to be preferably executed.

(1-2) The information processing device 100 identifies a first command group 103 corresponding to the determined first objective 102 among multiple commands. The multiple commands include, for example, a command group corresponding to the investigation objective and a command group corresponding to the control objective.

It is assumed that the command group corresponding to the investigation objective is free of, for example, a command whose execution is not preferable in terms of security. It is assumed that the command group corresponding to the investigation objective is free of a command whose execution is undesirable in terms of safety of the system, such as reboot for rebooting the system and restart for rebooting a service in the system. For example, when reboot, restart, or the like is executed, a problem may occur in the system or a service in the system, or data in the system may be damaged or lost.

The command group corresponding to the control objective includes, for example, commands that are useful for the control objective although it is not preferable to execute the commands in terms of security. The command group corresponding to the control objective includes, for example, commands useful for the control objective, such as reboot for rebooting the system and restart for rebooting a service in the system, although execution thereof is not preferable in terms of safety of the system.

As a result, the information processing device 100 may prevent execution of a command that is not desirable in terms of security unless execution of the command is useful for the first objective 102. The information processing device 100 may be configured to not execute a command whose execution is undesirable in terms of system safety unless execution of the command is useful for the first objective 102. The information processing device 100 may appropriately select a command to actually be executable among a plurality of commands. Even when the training model is a large-scale language model, the information processing device 100 may control the large-scale language model so as not to execute a command that is not preferable in terms of security or system safety.

(1-3) The information processing device 100 uses the agent 110 and repeats a first process 104 until it is determined that the determined first objective 102 is achieved. The first process 104 is a series of processes including, for example, a generating process 105, an executing process 106, and a summarizing process 107. For example, the information processing device 100 generates a second prompt requesting to repeat the first process 104 until it is determined that the first objective 102 is achieved. For example, the information processing device 100 inputs the generated second prompt to the agent 110 to cause the agent 110 to repeat the first process 104 and achieve the first objective 102.

The generating process 105 generates at least one command of the identified first command group 103. The generation is, for example, setting an argument of a command and obtaining a command in an executable format. The executing process 106 executes one of the commands generated in the generating process 105.

The summarizing process 107 summarizes a result of executing in the executing process 106, any one of the commands generated in the generating process 105. The summarization is, for example, extracting and summarizing information useful for the first objective 102 from a log obtained as a result of executing in the executing process 106, any one of the commands generated in the generating process 105.

The generating process 105 generates a command based on at least any of the first input content 101, a history of commands executed in the executing process 106 in the first process 104 up to the last time, and a summary of a result of executing the command, the summary being obtained by the summarizing process 107.

Here, specifically, in the first process 104 executed for the first time, there is no history of commands that have been executed in the executing process 106 in the first process 104 up to the previous time, and there is no content in which the result of executing the command is summarized in the summarizing process 107. Therefore, in the generating process 105 in the first process 104 performed for the first time, a command is generated based on the first input content 101.

Specifically, in the second and subsequent executions of the first process 104, there is a history of commands that have been executed in the executing process 106 for the first process 104 up to the last execution, and a summary of the result of executing the command, obtained by the summary process 107. Therefore, in the generating process 105 for the second and subsequent executions of the first process 104, a command is generated based on at least any of the first input content 101, the history of commands executed in the executing process 106, and the content summarized by the summarizing process 107.

Thus, even when the number of executable commands is enormous, the information processing device 100 may sequentially generate commands to be actually executed, the commands being generated appropriately and dynamically according to the state of the system. The information processing device 100 may appropriately and dynamically generate a command to be executed next with consideration of, for example, a history of executed commands, a summary of a result of executing a command, and the like. Specifically, the information processing device 100 may selectively execute a command that is preferably executed specifically for the objective of investigating a failure, and may easily and simply investigate the cause of the failure. Therefore, the information processing device 100 may appropriately investigate the failure and easily achieve the first objective 102.

(1-4) When determining that the first objective 102 is achieved, the information processing device 100 uses the agent 110 and generates answer content 108 corresponding to the first input content 101. For example, the information processing device 100 generates the answer content 108 corresponding to the first input content 101 based on a summary of the result of executing each of the one or more commands in the executing process 106 when repeatedly executing first process 104, the summary being obtained by the summarizing process 107.

The answer content 108 is, for example, information summarizing the content of information useful for the first objective 102 among logs obtained as a result of executing each of the one or more commands in the executing process 106 when repeatedly executing the first process 104.

Specifically, the information processing device 100 generates a third prompt requesting generation of the answer content 108 corresponding to the first input content 101. Specifically, the information processing device 100 inputs the generated third prompt to the agent 110, thereby causing the agent 110 to generate the answer content 108 corresponding to the first input content 101. Thus, the information processing device 100 may reduce the cost necessary to generate the answer content 108 corresponding to the first input content 101 even when the log is enormous.

The information processing device 100 outputs the generated answer content 108. The output format is, for example, display on a display, print output to a printer, transmission to another computer, or storage in a storage area. For example, the information processing device 100 outputs the answer content 108 so that the user may refer to the answer content 108. Thus, the information processing device 100 may make the answer content 108 available to externally. The information processing device 100 may facilitate investigation of the cause of a failure that has occurred in the system. For example, the information processing device 100 may reduce the workload, the work time, or the like of a worker who investigates the cause of the failure occurring in the system.

Here, while a case in which the information processing device 100 controls the agent 110 by sequentially inputting the first prompt, the second prompt, and the third prompt to the agent 110 has been described, the present disclosure is not limited hereto. For example, the agent 110 may automatically determine the first objective 102, identify the first command group 103, repeat the first process 104, and generate the answer content 108 in response to the first prompt. In this case, the information processing device 100 may generate and input the first prompt to the agent 110, and may omit generation of the second prompt and the third prompt.

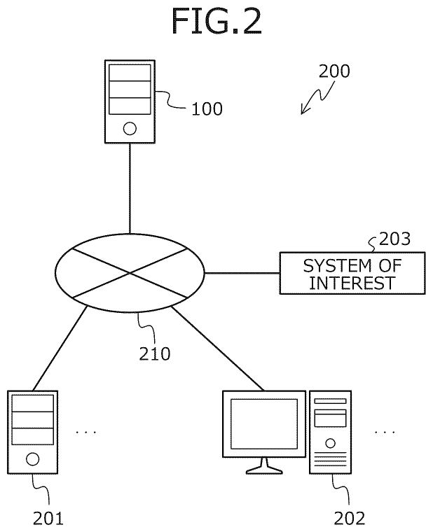

Here, while a case in which functions as the information processing device 100 are implemented by a single computer has been described, the present disclosure is not limited hereto. For example, functions of the information processing device 100 may be implemented by cooperation of multiple computers. For example, functions of the information processing device 100 may be implemented on a cloud. For example, a case in which the information processing device 100 cooperates with an external computer having the agent 110 will be described later with reference to FIG. 2.

Next, an example of an information processing system 200 to which the information processing device 100 depicted in FIG. 1 is applied will be described with reference to FIG. 2.

FIG. 2 is an explanatory diagram depicting an example of the information processing system 200. In FIG. 2, the information processing system 200 includes the information processing device 100, an agent device 201, one or more client apparatuses 202, and a system of interest 203.

In the information processing system 200, the information processing device 100 and the agent device 201 are coupled via a wired or wireless network 210. The network 210 is, for example, a local area network (LAN), a wide area network (WAN), the Internet, or the like.

In the information processing system 200, the information processing device 100 and the client apparatus 202 are coupled via the wired or wireless network 210. In the information processing system 200, the information processing device 100 or the agent device 201 and the system of interest 203 are coupled via the wired or wireless network 210.

The information processing device 100 is a computer for facilitating investigation of the cause of a failure that has occurred in the system of interest 203. The information processing device 100 obtains a processing request for investigating the cause of the failure that has occurred in the system of interest 203. The processing request includes, for example, a first input content representing a question content regarding a failure that has occurred in the system of interest 203. The information processing device 100 obtains the processing request, for example, by receiving the processing request from the client apparatus 202.

The information processing device 100 generates response content corresponding to the first input content by controlling an agent included in the agent device 201 based on the first input content in response to the processing request. For example, the information processing device 100 generates the response content corresponding to the first input content by controlling the agent as depicted in FIG. 1.

The information processing device 100 receives the response content corresponding to the first input content from the agent device 201. The information processing device 100 outputs the response content corresponding to the received first input content. For example, the information processing device 100 transmits the response content corresponding to the received first input content to the client apparatus 202. The information processing device 100 is, for example, a server or a PC.

The agent device 201 is a computer that executes the agent. The agent includes, for example, a training model. The training model is, for example, a large-scale language model. In response to receiving the processing request from the information processing device 100, the agent device 201, by the agent, generates response content corresponding to the first input content. The agent device 201 transmits the response content corresponding to the first input content to the information processing device 100. The agent device 201 is, for example, a server or a PC.

The client apparatus 202 is a computer configured to transmit a processing request to the information processing device 100. For example, the client apparatus 202 monitors the system of interest 203 and when a failure occurs in the system of interest 203, the client apparatus 202 automatically generates a processing request that includes the first input content and requests to investigate the cause of the failure that has occurred in the system of interest 203. For example, the client apparatus 202 may generate, based on an operation input of the user, a processing request that includes the first input content and requests to investigate the cause of the failure that has occurred in the system of interest 203.

The client device 202 outputs the response content corresponding to the first input content. For example, the client apparatus 202 outputs the response content corresponding to the first input content so that the user may refer to the response content. The client device 202 is, for example, a PC, a tablet terminal, or a smartphone. The system of interest 203 includes one or more computers. The system of interest 203 is, for example, an infrastructure that provides a specific service. The system of interest 203 is, for example, a virtualized platform.

Here, while a case in which the information processing device 100 is a device different from the agent device 201 has been described, the present disclosure is not limited hereto. For example, there may be a case where the information processing device 100 has a function as the agent device 201 and also operates as the agent device 201. In this case, the information processing system 200 may omit the agent device 201.

Here, while a case in which the information processing device 100 is a device different from the client apparatus 202 has been described, the present disclosure is not limited hereto. For example, the information processing device 100 may have a function as the client apparatus 202 and may also operate as the client apparatus 202. In this case, the information processing system 200 may omit the client device 202.

For example, the information processing system 200 may be applied to a case where a virtualized platform of Kubernetes (registered trademark) is operated and managed. In this case, the system of interest 203 is a virtualized platform. The information processing device 100 generates a command via Kubectl, for example, and controls the system of interest 203.

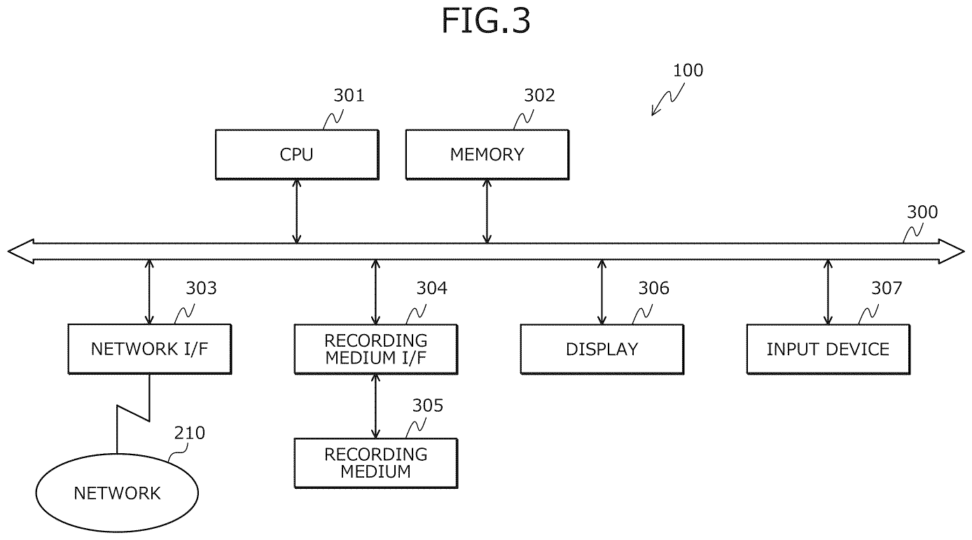

Next, with reference to FIG. 3, an example of a hardware configuration of the information processing device 100 is described.

FIG. 3 is a block diagram of an example of the hardware configuration of the information processing device 100. In FIG. 3, the information processing device 100 has a central processing unit (CPU) 301, a memory 302, and a network interface (I/F) 303. The information processing device 100 also has a recording medium I/F 304, a recording medium 305, a display 306, and an input device 307. Further, the components are coupled to each other by a bus 300.

Here, the CPU 301 governs overall control of the information processing device 100. The memory 302, for example, includes a read-only memory (ROM), a random-access memory (RAM), and a flash-ROM. In particular, for example, the flash-ROM and/or ROM stores therein various programs and the RAM is used as a work area of the CPU 301. Programs stored to the memory 302 are loaded onto the CPU 301, whereby encoded processes are executed by the CPU 301.

The network I/F 303 is coupled to the network 210 via a communications line and is coupled to other computers through the network 210. Further, the network I/F 303 administers an internal interface with the network 210 and controls the input and output of data with respect to the other computers. The network I/F 303, for example, is a modem, a LAN adapter, or the like.

The recording medium I/F 304 controls the reading and writing of data with respect to the recording medium 305 under the control of the CPU 301. The recording medium I/F 304 is, for example, a disk drive, a solid-state drive (SSD), a universal serial bus (USB) port, or the like. The recording medium 305 is a nonvolatile memory storing data written thereto under the control of the recording medium I/F 304. The recording medium 305 is, for example, a disk, a semiconductor memory, a USB memory, or the like. The recording medium 305 may be removable from the information processing device 100.

The display 306 displays data such as a cursor, icons, toolboxes, documents, images, or functional information. The display 306 is, for example, a cathode ray tube (CRT), a liquid crystal display, or an organic electroluminescence (EL) display. The input device 307 includes keys for inputting characters, numbers, or various instructions, and inputs data. The input device 307 is, for example, a keyboard or a mouse. The input device 307 may be, for example, a touch panel-type input pad, a numeric keypad, or the like.

The information processing device 100 may include, for example, a camera in addition to the above-described components. Further, the information processing device 100 may include, for example, a printer, a scanner, a microphone, a speaker, or the like in addition to the above-described components. The information processing device 100 may include, for example, the recording medium I/F 304 and/or the recording medium 305 in plural. The information processing device 100 may omit, for example, the display 306 and/or the input device 307. The information processing device 100 may omit the recording medium I/F 304 and the recording medium 305, for example.

An example of a hardware configuration of the agent device 201, for example, is a same as the example of the hardware configuration of the information processing device 100 depicted in FIG. 3 and thus, description thereof is omitted herein.

An example of a hardware configuration of the client device 202, for example, is a same as the example of the hardware configuration of the information processing device 100 depicted in FIG. 3 and thus, description thereof is omitted herein.

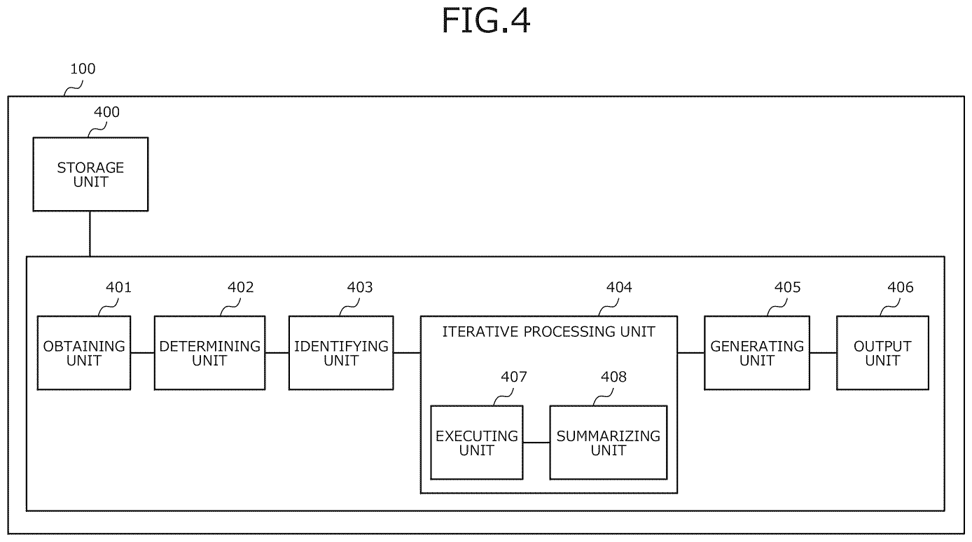

Next, an example of a functional configuration of the information processing device 100 will be described with reference to FIG. 4.

FIG. 4 is a block diagram depicting an example of a functional configuration of the information processing device 100. The information processing device 100 includes a storage unit 400, an obtaining unit 401, a determining unit 402, an identifying unit 403, an iterative processing unit 404, a generating unit 405, and an output unit 406. The iterative processing unit 404 includes an executing unit 407 and a summarizing unit 408.

The storage unit 400 is implemented by, for example, a storage area such as the memory 302 or the recording medium 305 depicted in FIG. 3. Hereinafter, while a case in which the storage unit 400 is included in the information processing device 100 will be described, the present disclosure is not limited hereto. For example, the storage unit 400 may be included in a device different from the information processing device 100 and the stored contents of the storage unit 400 may be referred to from the information processing device 100.

The obtaining unit 401 to the output unit 406 function as an example of a controller. Specifically, the functions of the obtaining unit 401 to the output unit 406 are realized, for example, by causing the CPU 301 to execute a program stored in a storage area such as the memory 302 or the recording medium 305 depicted in FIG. 3 or by the network I/F 303. Processing results obtained by the functional units are stored to, for example, a storage area such as the memory 302 or the recording medium 305 depicted in FIG. 3.

The storage unit 400 stores various types of information referred to or updated in the processes of the functional units. The storage unit 400 stores, for example, an agent including a training model. The training model is, for example, a large-scale language model. An agent is, for example, a software entity that operates to achieve a specific objective. The agent may be provided outside the information processing device 100, for example. The agent includes, for example, one training model used commonly in the processes of the functional units. The agent may include, for example, multiple training models used in processes of different functional units.

The agent may include, for example, a first training model trained for use in the process of the determining unit 402. The agent may include, for example, a second training model trained for use in process of the executing unit 407. The agent may include, for example, a third training model trained to be used in the processing of the summarizing unit 408. The agent may include, for example, a fourth training model trained for use in the process of the generating unit 405. The agent is set in advance by the user, for example. The agent may be obtained by the obtaining unit 401, for example.

The storage unit 400 stores, for example, input content indicating question content related to a failure that has occurred in the system. The input content is obtained by, for example, the obtaining unit 401. The storage unit 400 stores, for example, an objective corresponding to the input content. The objective is determined by, for example, the determining unit 402.

The storage unit 400 includes, for example, a first storage unit that identifiably stores a command group corresponding to each of multiple objectives, among multiple commands. The multiple objectives include, for example, an investigation objective, a control objective, and the like. The investigation objective means, for example, investigating a failure that has occurred in the system. The control objective means, for example, investigating a failure that has occurred in a system and controlling the system in which the failure has occurred.

The multiple commands include a command group corresponding to the investigation objective and a command group corresponding to the control objective. The command group corresponding to the investigation objective includes, for example, commands that are allowed to be executed for the investigation objective, and excludes commands whose execution is unpreferable for the investigation objective. It is assumed that the command group corresponding to the investigation objective excludes, for example, a command whose execution is unpreferable in terms of security. It is assumed that the command group corresponding to the investigation objective excludes, for example, a command whose execution is undesirable in terms of system safety.

The command group corresponding to the control objective includes, for example, a command that is allowed to be executed for the control objective, and excludes a command whose execution is unpreferable for the control objective. The command group corresponding to the control objective includes, for example, commands that are useful for the control objective although execution thereof is unpreferable in terms of security. The command group corresponding to the control objective includes, for example, a command useful for the control objective although execution of the command is unpreferable in terms of system safety.

Specifically, the first storage unit stores, in association with the investigation objective, a command group that is free of a command that may cause a problem in the system or a service in the system, or damage or loss of data in the system, among the multiple commands. Specifically, the first storage unit stores, in association with the control objective, a command group including a command that may cause a problem in the system or a service in the system or damage or loss of data in the system among the multiple commands. The stored content of the first storage unit is set in advance by the user, for example. The stored content of the first storage unit may be obtained by the obtaining unit 401, for example.

The storage unit 400 includes, for example, a second storage unit that stores a history of commands generated by the executing unit 407. The commands are generated by, for example, the executing unit 407. The second storage unit further stores a summary of the result of executing the commands, the summary being obtained by the summarizing unit 408. The summary of the result of executing the commands is generated by, for example, the summarizing unit 408. The storage unit 400 includes, for example, a third storage unit that stores an executed command evaluated to have a high degree of contribution to a predetermined objective. The evaluation is executed by, for example, the summarizing unit 408.

The obtaining unit 401 obtains various types of information used in the processes of the functional units. The obtaining unit 401 stores the obtained various types of information to the storage unit 400 or outputs the obtained various types of information to the functional units. In addition, the obtaining unit 401 may output various types of information stored in the storage unit 400 to the functional units. The obtaining unit 401 obtains various types of information based on, for example, an operation input of a user. For example, the obtaining unit 401 may receive various types of information from a device different from the information processing device 100.

The obtaining unit 401 obtains, for example, an agent. Specifically, the obtaining unit 401 obtains the agent by receiving an input of the agent. Specifically, the obtaining unit 401 may obtain the agent by receiving the agent from another computer. The other computer is, for example, the client device 202.

The obtaining unit 401 obtains, for example, a processing request requesting generation of answer content corresponding to input content. The processing request includes, for example, the input content. Specifically, the obtaining unit 401 obtains the processing request by receiving an input of the processing request. Specifically, the obtaining unit 401 may obtain the processing request by receiving the processing request from another computer. The other computer is, for example, the client device 202.

The obtaining unit 401 obtains, for example, input content. Specifically, the obtaining unit 401 obtains the input content by receiving an input of the input content. Specifically, the obtaining unit 401 may obtain the input content by receiving the input content from another computer. The other computer is, for example, the client device 202. Specifically, the obtaining unit 401 may obtain the input content by extracting the input content from the processing request.

The obtaining unit 401 obtains, for example, the stored content of the first storage unit. Specifically, the obtaining unit 401 obtains the stored content of the first storage unit by receiving an input of the stored content of the first storage unit. Specifically, the obtaining unit 401 may obtain the stored content of the first storage unit by receiving the stored content of the first storage unit from another computer. The other computer is, for example, the client device 202.

The obtaining unit 401 may receive a start trigger for starting the process of any of the functional units. The start trigger is, for example, a predetermined operation input by the user. The start trigger may be, for example, reception of predetermined information from another computer. The start trigger may be, for example, output of predetermined information by any of the functional units.

For example, the obtaining unit 401 may regard obtaining a processing request as a start trigger for starting the processes of the determining unit 402, the identifying unit 403, the iterative processing unit 404, and the generating unit 405. Here, a case where the obtaining unit 401 obtains a processing request requesting generation of answer content corresponding to the first input content is considered. The processes of the functional units in this case will be described.

The determining unit 402 uses the agent to determine the first objective corresponding to the first input content obtained by the obtaining unit 401. The determining unit 402, for example, generates a first prompt requesting determination of the first objective corresponding to the first input content and inputs the first prompt to the agent and thereby uses the agent to determine the first objective corresponding to the first input content. The first prompt includes, for example, the first input content. Thus, the determining unit 402 may obtain the first objective serving as a guideline for determining what command is preferably executed.

The identifying unit 403 identifies, among the multiple commands, a first command group corresponding to the first objective determined by the determining unit 402. For example, the identifying unit 403 identifies, among the multiple commands, a first command group corresponding to the determined first objective by referring to the storage unit 400. For example, the identifying unit 403 may use the agent and identify, among the multiple commands, a first command group corresponding to the determined first objective. Specifically, the identifying unit 403 uses the agent and generates a second prompt requesting identification of a first command group that is among the multiple commands and corresponds to the determined first objective, and inputs the second prompt to the agent and thereby identifies the first command group.

As a result, the identifying unit 403 may narrow down the first command group that may be executed so that a command whose execution is unpreferable in terms of security is not executed unless execution thereof is useful for the first objective. The identifying unit 403 may narrow down the first command group that may be executed so that a command whose execution is unpreferable in terms of system safety is not executed unless execution thereof is useful for the first objective. The identifying unit 403 may appropriately select a command to actually be executable, among the multiple commands.

The iterative processing unit 404 uses the agent and repeatedly performs the first process until it is determined that the first objective determined by the determining unit 402 is achieved. The first process is, for example, a series of processes including a process of generating and executing at least one command of the first command group identified by the identifying unit 403 and a process of summarizing a result of executing the one or more commands.

In the first process, the executing unit 407 uses the agent to generate and execute at least one command in the first command group identified by the identifying unit 403. For example, the executing unit 407 refers to the storage unit 400 and generates one of the commands based on at least one of the first input content, the history of the commands executed by the executing unit 407 in the first process, and the summary of the result of executing the commands, obtained by the summarizing unit 408.

Specifically, the executing unit 407 generates a third prompt for requesting generation and execution of at least one command of the first command group, and inputs the third prompt to the agent to thereby generate a command using the agent. Here, in the first process, in response to the generation of a command, the executing unit 407 stores the generated command to the storage unit 400.

Thus, even when the number of executable commands is enormous, the executing unit 407 may sequentially generate commands to be actually executed, the executing unit 407 generating the commands appropriately and dynamically according to the state of the system. The executing unit 407 may appropriately and dynamically generate a command to be executed next with consideration of, for example, the history of executed commands and the summary of the result of executing commands. The executing unit 407 may appropriately update the history of executed commands in preparation for the next execution of the first process.

The summarizing unit 408 uses the agent and summarizes the result of executing of any command by the executing unit 407 in the first process. For example, the summarizing unit 408 generates a fourth prompt requesting a summary of the result of executing any of the commands by the executing unit 407 and inputs the fourth prompt to the agent and thereby uses the agent to summarize the result of executing any of the commands by the executing unit 407. Here, when summarizing the result of executing any of the commands by the executing unit 407, the summarizing unit 408 stores to the storage unit 400, the summary of the result of executing any of the commands by the executing unit 407.

As a result, the summarizing unit 408 may generate a summary of the result of executing of any of the commands by the executing unit 407, the summary representing the content of investigating the cause of a failure occurring in the system, according to the result of executing any of the commands by the executing unit 407. In preparation for the next execution of the first process, the summarizing unit 408 may accumulate, in the storage unit 400, summaries of the result of executing any of the commands by the executing unit 407.

The summarizing unit 408 may use the agent to store, in the storage 400, a command that has been executed in the first process and that has been evaluated as having a high degree of contribution to the determined first objective. For example, the summarizing unit 408 uses the agent and evaluates the degree of contribution to the first objective determined by the determining unit 402 for any of the commands by verifying the result of executing the command by the executing unit 407.

Specifically, the summarizing unit 408 generates a fifth prompt requesting evaluation of the degree of contribution to the first objective determined by the determining unit 402 for any command executed by the executing unit 407. Specifically, the summarizing unit 408 inputs the generated fifth prompt to the agent and thereby uses the agent to evaluate the degree of contribution to the first objective determined by the determining unit 402 for any command.

For example, using the agent, the summarizing unit 408 stores, to the storage unit 400, a command that has been executed by the executing unit 407 in the first process and that has been evaluated to have a high degree of contribution to the first objective determined by the determining unit 402. As a result, the summarizing unit 408 may store a command that is useful when generating the answer content corresponding to the first input content in preparation for a case in which a processing request for generating the answer content corresponding to a second input content different from the first input content is obtained.

The generating unit 405 uses the agent and when determining that the first objective has been achieved, generates answer content corresponding to the first input content, based on a summary of the result of executing each command of the one or more commands that have been executed in the first process. The answer content is, for example, information obtained by summarizing information useful for the first objective determined by the determining unit 402, among logs obtained as a result of executing each of one or more commands by the executing unit 407 in repeatedly executing the first process.

The generating unit 405 uses the agent and generates, for example, a sixth prompt requesting generation of answer content corresponding to the first input content, and inputs the sixth prompt to the agent and thereby generates the answer content corresponding to the first input content. As a result, even when a large number of logs are obtained as a result of executing each of the commands, the generating unit 405 may reduce the cost necessary to generate the answer content corresponding to the first input content.

Here, it is conceivable that, after the generating unit 405 generates the answer content corresponding to the first input content, the obtaining unit 401 obtains a processing request requesting generation of an answer content corresponding to a second input content different from the first input content. Processes of each functional unit in this case will be described.

In this case, the determining unit 402 determines the second objective corresponding to the second input content by using the agent as in the case of generating the answer content corresponding to the first input content. Further, the identifying unit 403 identifies, among the multiple commands, a second command group corresponding to the determined second objective as in the case of generating the answer content corresponding to the first input content.

The iterative processing unit 404 repeatedly performs the second process using the agent until determining that the second objective determined by the determining unit 402 is achieved. The second process is a series of processes including a process of generating and executing at least one command of the second command group identified by the identifying unit 403 and a process of summarizing a result of executing the one or more commands.

Here, unlike the case of generating the answer content corresponding to the first input content, the executing unit 407 may use a history of commands that have been executed in the first process repeatedly performed in the past and evaluated to have a high degree of contribution to the first objective determined in the past. The executing unit 407 refers to the storage unit 400 and generates a command based on at least one of the second input content, the history of executed commands in the second process, a summary obtained by the summarizing unit 408, and the history of executed commands in the first process. The executing unit 407 may generate any command as in the case of generating the answer content corresponding to the first input content.

The summarizing unit 408 summarizes the result of executing of any of the commands by the executing unit 407 as in the case of generating the answer content corresponding to the first input content. In addition, the generating unit 405 generates the answer content corresponding to the second input content by using the agent, as in the case of generating the answer content corresponding to the first input content. Thus, the information processing device 100 may be used in a case where the answer content corresponding to the second input content different from the first input content is generated with consideration of a command that was useful when the answer content corresponding to the first input content was generated in the past. The information processing device 100 may improve the efficiency of generating the answer content corresponding to the second input content.

The output unit 406 outputs a process result of at least one of the functional units. The output format is, for example, display on a display, print output to a printer, transmission to an external device by the network I/F 303, or storage to a storage area such as the memory 302 or the recording medium 305. Thus, the output unit 406 may notify the user of the processing result of at least one of the functional units, and the convenience of the information processing device 100 may be improved.

The output unit 406 outputs, for example, the answer content corresponding to the input content and generated by the generating unit 405. The output unit 406 outputs, for example, the answer content corresponding to the first input content. Specifically, the output unit 406 outputs the answer content corresponding to the first input content so that the user may refer to the answer content. Specifically, the output unit 406 transmits the answer content corresponding to the first input content to another computer. The other computer is, for example, the client device 202.

The output unit 406 outputs, for example, the answer content corresponding to the second input content. Specifically, the output unit 406 outputs the answer content corresponding to the second input content so that the user may refer to the answer content. Specifically, the output unit 406 transmits the answer content corresponding to the second input content to another computer. The other computer is, for example, the client device 202. Thus, the output unit 406 may make the answer content corresponding to the input content available externally. The output unit 406 may facilitate investigation of the cause of a failure occurring in the system via use of the answer content corresponding to the input content.

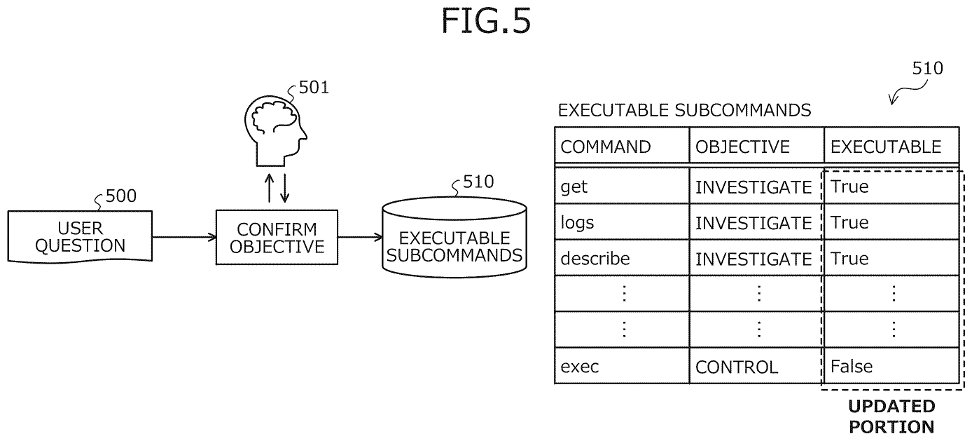

Next, an example of operation of the information processing device 100 will be described with reference to FIGS. 5 to 9.

FIGS. 5, 6, 7, 8, and 9 are explanatory diagrams depicting an example of operation of the information processing device 100. In FIG. 5, the information processing device 100 may use an agent 501. The agent 501 is included in, for example, the information processing device 100. The agent 501 includes, for example, a large-scale language model.

(5-1) The information processing device 100 obtains a user question 500 as an input content. The user question 500 relates to, for example, a failure that has occurred in the system. The user question 500 is, for example, a text asking whether an error has occurred.

For example, the information processing device 100 obtains the user question 500 by receiving an input of the user question 500 based on an operation input of the user. For example, the information processing device 100 may obtain the user question 500 by receiving the user question 500 from another computer. The other computer is, for example, the client device 202.

(5-2) The information processing device 100 stores an executable subcommand management table 510 for storing executable subcommands that may be executed by the agent 501. The executable subcommand management table 510 is implemented by, for example, a storage area such as the memory 302 or the recording medium 305 of the information processing device 100 depicted in FIG. 3. The executable subcommand management table 510 has fields of command, objective, and executable.

In the command field, each subcommand of multiple subcommands is set. In the objective field, one of multiple objectives for which the subcommand is allowed to be executed is set. In the executable field, flag information indicating whether the subcommand is executable is set. When the flag information is True, it indicates that the subcommand is executable. When the flag information is False, it indicates that the subcommand is not executable.

The information processing device 100 uses the agent 501 to update the executable subcommand management table 510 so that executable subcommands that may be executed by the agent 501 among the multiple subcommands may be identified. Specifically, the agent 501 determines the objective “investigation” corresponding to the user question 500. Specifically, the agent 501 updates the executable subcommand management table 510 so as to set the flag information “True” associated with the subcommand corresponding to the determined objective “investigation”. Specifically, the agent 501 updates the executable subcommand management table 510 so as to set flag information “False” associated with a subcommand that does not correspond to the determined objective “investigation”.

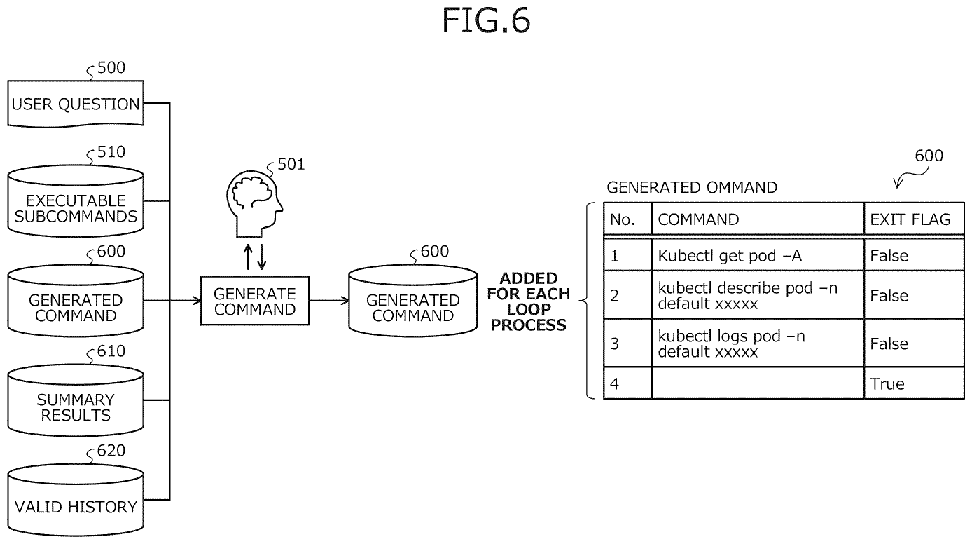

Thus, the information processing device 100 may appropriately select executable subcommands with consideration of security, system safety, or the like according to the objective “investigation” corresponding to the user question 500 and store the executable subcommands in an identifiable manner. Therefore, the information processing device 100 may prevent a subcommand that is not preferable to be executed in terms of security or system safety from being executed unless the subcommand is useful for the objective “investigation” corresponding to the user question 500. Next, FIG. 6 will be described.

In FIG. 6, the information processing device 100 stores a generated command management table 600 for storing a history of generated commands. The generated command management table 600 is implemented by, for example, a storage area such as the memory 302 or the recording medium 305 of the information processing device 100 depicted in FIG. 3. The generated command management table 600 has fields of No., command, and exit flag.

In the “No.” field, a number identifying a generated command generated by the agent 501 among one or more executable subcommands is set. Among the one or more executable subcommands, a generated command generated by the agent 501 is set in the “command” field. In the “exit flag” field, the exit flag corresponding to the generated command is set. When the exit flag is True, it indicates that the generated command has ended. When the exit flag is False, it indicates that the generated command has not ended.

The information processing device 100 stores a summary result management table 610 for storing a summary obtained by summarizing the results of executing a generated command. The summary result management table 610 is implemented by, for example, a storage area such as the memory 302 or the recording medium 305 of the information processing device 100 depicted in FIG. 3. The summary result management table 610 has fields of No. and command.

In the “No.” field, a number for identifying a summary obtained by summarizing the result executing the generated command is set. In the “command” field, a summary obtained by summarizing the result executing the generated command is set.

The information processing device 100 stores a valid history management table 620 for storing generated commands that are valid for solving a failure, among generated commands executed by the agent 501 in the past. The valid history management table 620 is implemented by, for example, a storage area such as the memory 302 or the recording medium 305 of the information processing device 100 depicted in FIG. 3. The valid history management table 620 includes fields of execution count and command.

In the “execution count” field, the number of times the generated command has been executed in the past is set. In the “command” field, a generated command executed in the past is set. Specifically, a generated command that has been executed in the past and that has been evaluated to be effective in solving a failure is set in the command field.

The information processing device 100 uses the agent 501 and repeats a loop process while referring to the user question 500 and the various tables until determining that the objective “investigation” corresponding to the user question 500 is achieved. The loop process is a series of processes of generating and executing any executable subcommand as a generated command and summarizing the result of executing the generated command. The loop process will be specifically described with reference to FIGS. 6 to 8. The various tables are, for example, the executable subcommand management table 510, the generated command management table 600, the summary result management table 610, and the valid history management table 620.

(6-1) In FIG. 6, the information processing device 100 uses the agent 501 and generates, among one or more executable subcommands, an executable subcommand as a generated command, for example, by referring to the user question 500 and various tables. For example, the agent 501 refers to the user question 500 and various tables, and generates, as the generated command, an executable subcommand among the one or more executable subcommands.

Here, when the loop process is performed for the first time, it is considered that the generated command management table 600 and the summary result management table 610 are empty. In this case, specifically, the agent 501 generates an executable subcommand based on the user question 500 and the executable subcommand management table 510. Specifically, the agent 501 may generate an executable subcommand based on the user question 500, the executable subcommand management table 510, and the validity history management table 620.

When the loop process is executed for a second or subsequent time, it is considered that the generated command management table 600 and the summary result management table 610 are not empty. In this case, specifically, the agent 501 generates an executable subcommand based on the user question 500, the executable subcommand management table 510, the generated command management table 600, and the summary result management table 610. Specifically, the agent 501 may generate an executable subcommand based on the user question 500, the executable subcommand management table 510, the generated command management table 600, the summary result management table 610, and the valid history management table 620.

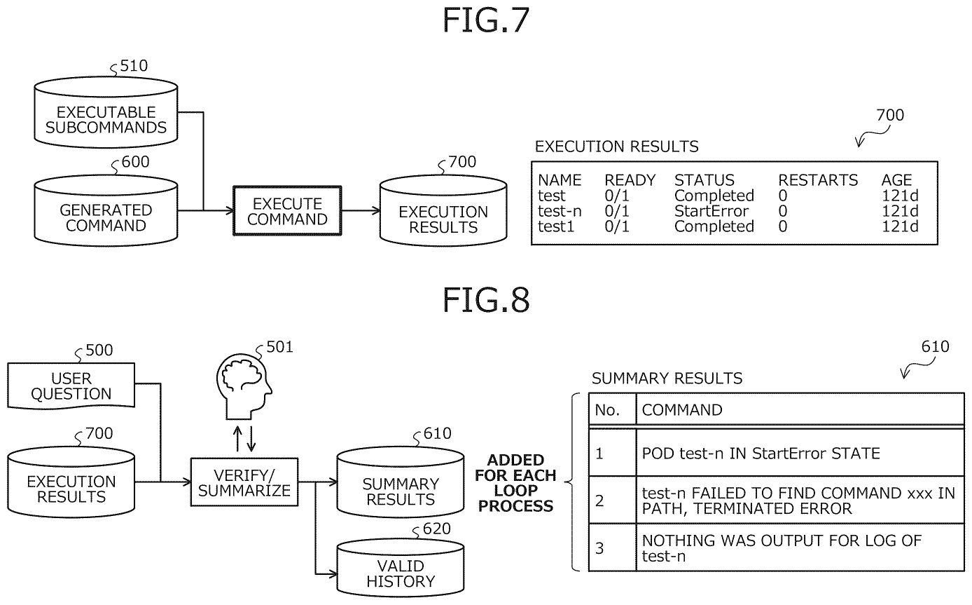

(6-2) The information processing device 100 stores the generated command to the generated command management table 600 using, for example, the agent 501. Specifically, the agent 501 stores the generated command to the generated command management table 600. As a result, the information processing device 100 may add the generated command every time the loop process is performed, and may record the history of the generated command. The information processing device 100 may facilitate appropriate and dynamic generation of the generated command in the current execution of the loop process according to the flow of the investigation and the state of the investigation in the loop process up to the previous execution thereof. The information processing device 100 may refer to the history of the generated command in the next execution of the loop process, and may easily generate the generated command appropriately and dynamically. Next, FIG. 7 will be described.

(7-1) In FIG. 7, the information processing device 100, by using, for example, the agent 501, refers to the executable subcommand management table 510 and the generated command management table 600 and executes the generated command generated in the current execution of the loop process. For example, the information processing device 100 uses the agent 501 to store to the storage unit 700, an execution result of executing the generated command. The execution result is, for example, a log.

Specifically, the agent 501 executes the generated command generated in the current execution of the loop process. Specifically, the agent 501 stores to the storage unit 700, an execution result of executing the generated command. As a result, the information processing device 100 may accumulate a log used when investigating the cause of a failure that has occurred in the system. Next, FIG. 8 will be described.

(8-1) In FIG. 8, the information processing device 100 uses, for example, the agent 501 to refer to the user question 500 and the execution result stored in the storage unit 700, to verify and summarize the execution result to generate a summary result, and stores the summary result to the summary result management table 610. Thus, the information processing device 100 may refer to the summary result in the next execution of the loop process, and may easily generate the generated command appropriately and dynamically.

The information processing device 100 uses the agent 501 and verifies the execution result and updates the stored content of the valid history management table 620, based on the generated command evaluated to be valid for solving the failure. As a result, the information processing device 100 may store the generated command evaluated to be valid this time in preparation for a case in which the user question 500 is obtained a subsequent time as another input content and answer content corresponding to the user question 500 is to be generated.

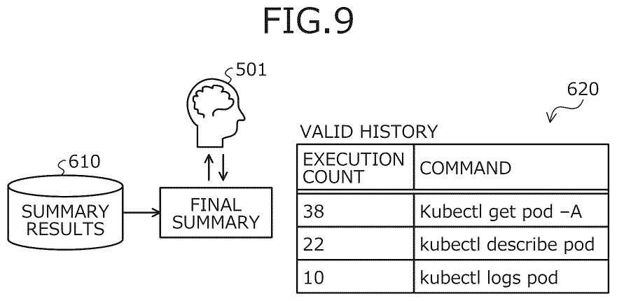

The information processing device 100 uses the agent 501 and determines whether the objective “investigation” corresponding to the user question 500 is achieved. Specifically, the agent 501 determines whether the objective “investigation” corresponding to the user question 500 is achieved. The information processing device 100 uses the agent 501 and when determining that the objective “investigation” corresponding to the user question 500 is not achieved, performs the loop process again. Next, FIG. 9 will be described.

In FIG. 9, the information processing device 100 uses the agent 501 and when it is determined that the objective “investigation” corresponding to the user question 500 is achieved, refers to the summary result management table 610 and generates an answer content in which summary results are summarized. Specifically, the agent 501 generates the answer content in which the summary results are summarized. The information processing device 100 outputs the generated answer content. For example, the information processing device 100 outputs the generated answer content so that the user may refer to the answer content.

Further, the information processing device 100 uses the agent 501 to update the stored content of the valid history management table 620 based on the generated command evaluated to be valid for solving the failure when summarizing the summary results. As a result, the information processing device 100 may store the generated command evaluated to be valid this time in preparation for a case in which the user question 500 is obtained a subsequent time as another input content and an answer content corresponding to the user question 500 is to be generated.

Thus, the information processing device 100 may allow the user to refer to the answer content corresponding to the user question 500 which is the input content, and may reduce the cost necessary when investigating the cause of a failure occurring in the system. The information processing device 100 may reduce, for example, the workload and work time of the user.

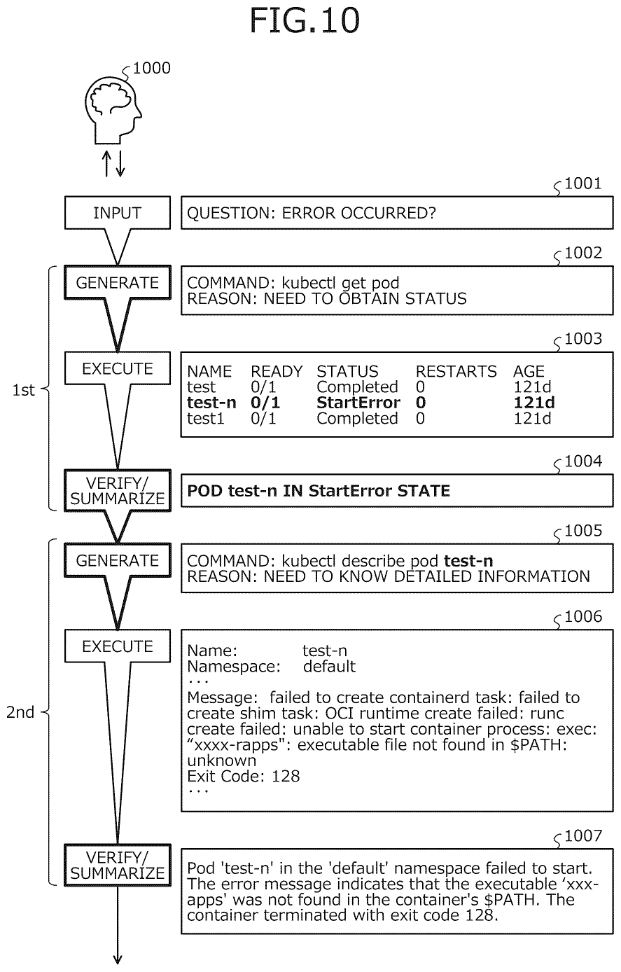

Next, a specific example of the operation of the information processing device 100 will be described with reference to FIGS. 10 to 15.

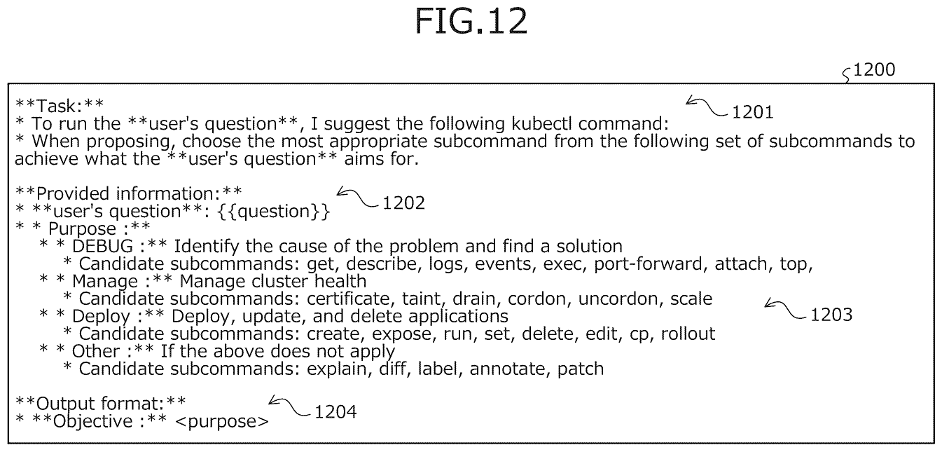

FIGS. 10, 11, 12, 13, 14, and 15 are explanatory diagrams depicting specific examples of the operation of the information processing device 100. (10-1) In FIG. 10, the information processing device 100 obtains an input content 1001. The information processing device 100 generates a prompt requesting determination of an objective corresponding to the input content 1001, based on a template 1200 to be described later with reference to FIG. 12, and inputs the prompt to the agent 1000. Tn response to the input prompt, the agent 1000 determines an objective corresponding to the input content 1001 using the large-scale language model. The information processing device 100 performs a first execution of a loop process as described below.

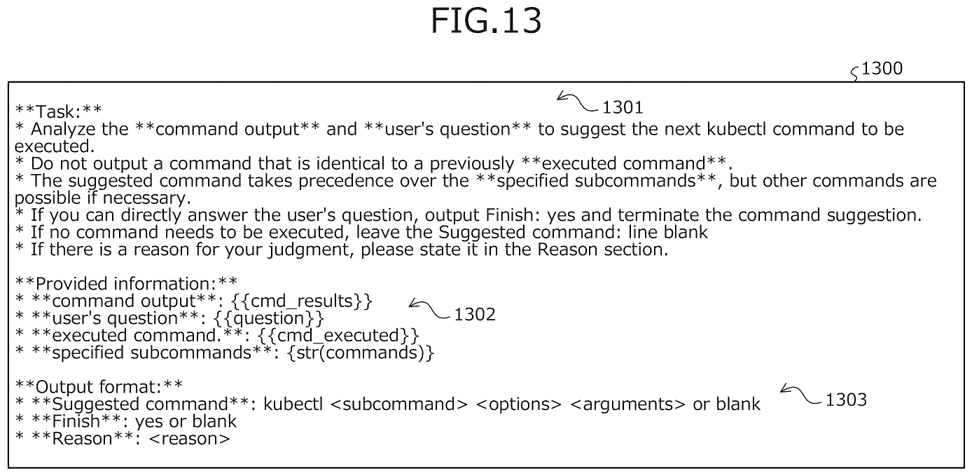

(10-2) The information processing device 100 generates a prompt requesting generation of at least one command of a command group corresponding to the determined objective, based on a template 1300 to be described later with reference to FIG. 13, and inputs the prompt to the agent 1000. In response to the input prompt, the agent 1000 identifies a command group corresponding to the determined objective using the large-scale language model, and generates at least one command of the identified command group. The agent 1000 outputs, for example, a text 1002 indicating the generated command and a reason for generating the command.

(10-3) The information processing device 100 executes the generated command based on the text 1002. The information processing device 100 may execute the generated command using, for example, the agent 1000. The information processing device 100 obtains a log 1003 as a result of executing the generated command.

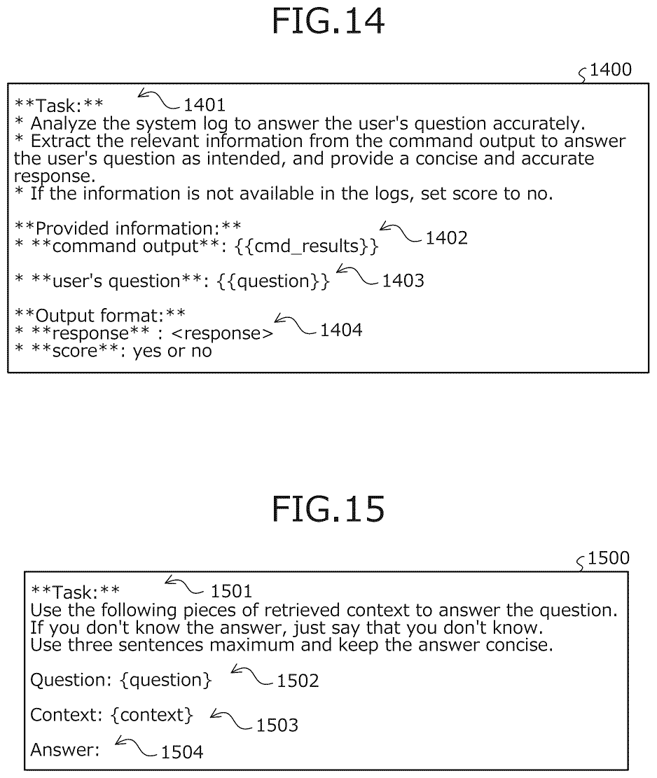

(10-4) The information processing device 100 generates a prompt requesting verification and summarization of the content of the obtained log 1003, based on a template 1400 described later with reference to FIG. 14, and inputs the prompt to the agent 1000. In response to the input prompt, the agent 1000 uses the large-scale language model to verify and summarize the content of the obtained log 1003. For example, the agent 1000 outputs a text 1004 representing a summary of results obtained by verifying and summarizing the content of the log 1003.

(10-5) The information processing device 100 uses the agent 1000 and determines whether the objective corresponding to the input content 1001 is achieved. Here, the agent 1000 determines that the objective corresponding to the input content 1001 is not achieved. Here, since the information processing device 100 has not achieved the objective corresponding to the input content 1001, the information processing device 100 performs a second execution of the loop process as described below.

As in (10-2), the information processing device 100 generates a prompt requesting generation of at least one command of the command group corresponding to the determined objective, and inputs the prompt to the agent 1000. In response to the input prompt, the agent 1000 identifies a command group corresponding to the determined objective using the large-scale language model, and generates at least one command of the identified command group. The agent 1000 outputs, for example, a text 1005 indicating the generated command and a reason for generating the command.

(10-6) The information processing device 100 executes the generated command based on the text 1005 as in (10-3). The information processing device 100 may execute the generated command using, for example, the agent 1000. The information processing device 100 obtains a log 1006 as a result of executing the generated command.

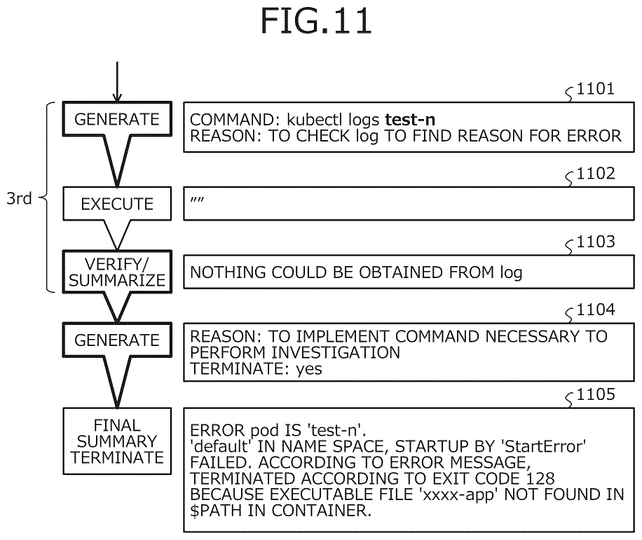

(10-7) As in (10-4), the information processing device 100 generates a prompt requesting verification and summarization of the content of the obtained log 1006, and inputs the prompt to the agent 1000. In response to the input prompt, the agent 1000 uses the large language model to verify and summarize the content of the obtained log 1006. For example, the agent 1000 outputs a text 1007 representing a summary of results obtained by verifying and summarizing the content of the log 1006. Next, FIG. 11 will be described.

(11-1) In FIG. 11, the information processing device 100 uses the agent 1000 and determines whether the objective corresponding to the input content 1001 is achieved. Here, the agent 1000 determines that the objective corresponding to the input content 1001 is not achieved. Here, since the information processing device 100 has not achieved the objective corresponding to the input content 1001, the information processing device 100 performs a third execution of the loop process.

Since the objective has not been achieved, the information processing device 100 generates a prompt requesting generation of at least one command of the command group corresponding to the determined objective and inputs the prompt to the agent 1000 as in (10-2). In response to the input prompt, the agent 1000 identifies a command group corresponding to the determined objective using the large-scale language model, and generates at least one command of the identified command group. The agent 1000 outputs, for example, a text 1101 indicating the generated command and a reason for generating the command.

(11-2) The information processing device 100 executes the generated command based on the text 1101 as in (10-3). The information processing device 100 may execute the generated command using, for example, the agent 1000. The information processing device 100 obtains a log 1102 as a result of executing the generated command.

(11-3) As in (10-4), the information processing device 100 generates a prompt requesting verification and summarization of the content of the obtained log 1102, and inputs the prompt to the agent 1000. In response to the input prompt, the agent 1000 uses the large-scale language model to verify and summarize the content of the obtained log 1102. For example, the agent 1000 outputs a text 1103 representing a summary of results obtained by verifying and summarizing the content of the log 1102.

(11-4) The information processing device 100 uses the agent 1000 and determines whether the objective corresponding to the input content 1001 is achieved. Here, the agent 1000 determines that the objective corresponding to the input content 1001 is achieved. Since the objective corresponding to the input content 1001 is achieved, the agent 1000 outputs a text 1104 indicating a reason why it is determined that the objective is achieved. Here, since the objective corresponding to the input content 1001 is achieved based on the text 1104, the information processing device 100 determines not to repeat the loop process.

The information processing device 100 generates a prompt requesting collection of summary results for the loop process repeated multiple times, based on a template 1500 to be described later with reference to FIG. 15, and inputs the prompt to the agent 1000. In response to the input prompt, the agent 1000 uses the large-scale language model to generate and output a text 1105 in which texts 1004, 1007, and 1103 representing a summary of the results of the loop process repeated multiple times are collectively included.

(11-5) The information processing device 100 outputs the text 1105 as the answer content corresponding to the input content 1001 so that the user may refer to the text 1105. Thus, the information processing device 100 may reduce the cost necessary to generate the answer content corresponding to the input content 1001 even when the log is enormous. The cost is, for example, a workload and a work time necessary for a worker to investigate the cause of a failure. Specifically, the information processing device 100 may reduce the work time by about 85% as compared with a case in which the worker manually investigates the cause of a failure.

The information processing device 100 may sequentially generate and execute commands appropriately and dynamically with consideration of security and system safety. The information processing device 100 may make the answer content available externally, and may facilitate investigation of the cause of a failure that has occurred in the system. The information processing device 100 may facilitate investigation of the cause of a failure occurring in the system even when the worker is not familiar with the system.

The information processing device 100 enables the worker to grasp what commands are preferably executed sequentially. Therefore, the information processing device 100 may enhance the skill of the worker to operate and manage the system. Next, FIG. 12 will be described.

In FIG. 12, a template 1200 is a source for generating a prompt requesting to determine an objective corresponding to input content 1001. The template 1200 includes, for example, a portion 1201 representing the requested processing content. The template 1200 includes, for example, a portion 1202 for setting the input content 1001. The template 1200 includes, for example, a portion 1203 representing a list of objectives. The template 1200 includes, for example, a portion 1204 for designating an output format. Next, FIG. 13 will be described.

In FIG. 13, a template 1300 is a source for generating a prompt requesting generation of at least one command among a command group corresponding to an objective. The template 1300 includes, for example, a portion 1301 representing the requested processing content. The template 1300 includes, for example, a portion 1302 for setting reference information.

The reference information includes, for example, an input content 1001, a history of commands executed in the past, a command group corresponding to an objective, and an execution result of executing a command in the past. The input content 1001 corresponds to a question. The history of commands executed in the past corresponds to cmd_executed. The command group corresponding to the objective corresponds to str (commands). The execution result of the command executed in the past corresponds to cmd_results. The template 1300 includes, for example, a portion 1303 for designating an output format. Next, FIG. 14 will be described.

In FIG. 14, a template 1400 serves as a source for generating a prompt requesting verification and summarization of a log that is an execution result of executing a command. The template 1400 includes, for example, a portion 1401 representing the requested processing content. The template 1400 includes, for example, portions 1402 and 1403 for setting reference information.

The reference information includes, for example, an input content 1001 and an execution result obtained by executing the command generated this time. The input content 1001 corresponds to a question and is set in the portion 1403. An execution result obtained by executing the command generated this time corresponds to cmd_results and is set in the portion 1402. The template 1400 includes, for example, a portion 1404 for designating an output format. Next, FIG. 15 will be described.

In FIG. 15, a template 1500 is a source for generating a prompt requesting to summarize summary results for the loop process repeated multiple times. The template 1500 includes, for example, a portion 1501 representing the requested processing content. The template 1500 includes, for example, a portion 1502 for setting the input content 1001. The template 1500 includes, for example, a portion 1503 for setting a summary result in loop process repeated a plurality of times. The template 1500 includes, for example, a portion 1504 for designating an output format.

Here, while a case in which the agent 1000 sequentially executes each process of the series of processes depicted in FIGS. 10 and 11 in response to receiving the prompt requesting the process has been described, the present disclosure is not limited hereto. For example, the agent 1000 may execute the series of processes depicted in FIGS. 10 and 11 in response to receiving one prompt requesting execution of the series of processes depicted in FIGS. 10 and 11. For example, the agent 1000 may automatically generate a prompt corresponding to a subsequent process based on the templates 1200, 1300, 1400, and 1500 when executing each process of the series of processes after receiving one prompt.

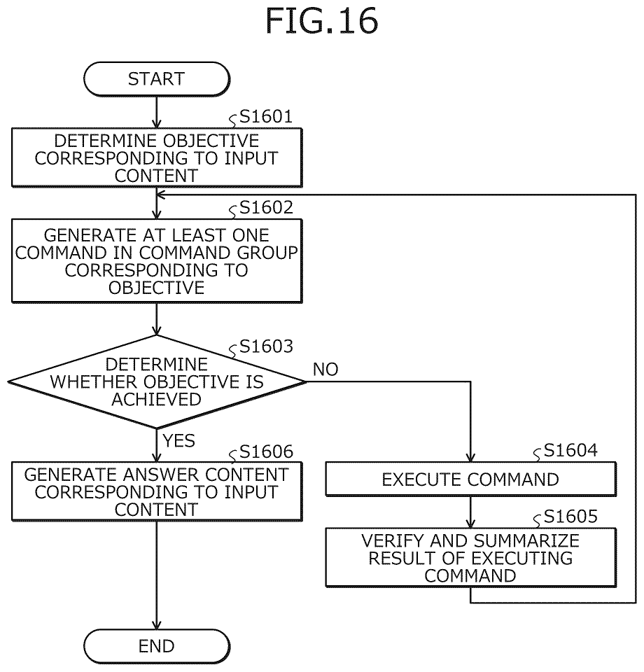

Next, an example of an overall process procedure executed by the information processing device 100 will be described with reference to FIG. 16. The overall process is implemented by, for example, the CPU 301, storage areas such as the memory 302 and the recording medium 305, and the network I/F 303 depicted in FIG. 3.

FIG. 16 is a flowchart depicting an example of the overall process procedure. In FIG. 16, the information processing device 100 uses an agent and determines an objective corresponding to input content (step S1601). Then, the information processing device 100 uses the agent and generates at least one command in the command group corresponding to the determined objective (step S1602).

Next, the information processing device 100 uses the agent and determines whether the determined objective is achieved (step S1603). Here, when the determined objective is achieved (step S1603: YES), the information processing device 100 proceeds to the process at step S1606. On the other hand, when the determined objective is not achieved (step S1603: NO), the information processing device 100 proceeds to the process at step S1604.

At step S1604, the information processing device 100 uses the agent and executes the generated command (step S1604). Next, the information processing device 100 uses the agent and verifies and summarizes a result of executing the generated command (step S1605). Then, the information processing device 100 returns to the process at step S1602.

At step S1606, the information processing device 100 uses the agent and generates an answer content corresponding to the input content, based on a summary of a result of executing the generated command (step S1606). Then, the information processing device 100 ends the entire process.

Here, the information processing device 100 may change the order of the processes of some steps in the flowchart in FIG. 16 and execute the processes. For example, the order of the process at step S1603 may be changed. Further, the information processing device 100 may omit the processes of some steps in the flowchart in FIG. 16.

As described above, according to the information processing device 100, it is possible to use the agent and determine the first objective corresponding to the first input content. According to the information processing device 100, it is possible to identify, among multiple commands, a first command group corresponding to the determined first objective. According to the information processing device 100, it is possible to use the agent and repeat the first process of generating and executing at least one command of the first command group and summarizing a result of executing the one or more commands until it is determined that the first object is achieved. According to the information processing device 100, in the first process, a command may be generated based on at least any of the first input content, the history of commands executed in the first process, and the summary of the result of executing the command. According to the information processing device 100, in a case where it is determined that the first object is achieved, it is possible to use the agent and generate and output the answer content corresponding to the first input content based on the summary of the result of executing each command that has been executed in the first process. Thus, the information processing device 100 may appropriately and dynamically generate and execute a command according to the first objective, and may easily achieve the first objective. For example, the information processing device 100 may easily achieve the first objective of investigating the cause of a failure. For example, the information processing device 100 may reduce the workload and the work time on the worker who investigates the cause of a failure.

According to the information processing device 100, it is possible to identify the first command group by referring to the first storage unit that stores command groups among the multiple commands, corresponding to each of multiple objectives in an identifiable manner. Thus, the information processing device 100 may appropriately identify a first command group according to the first objective.

According to the information processing device 100, when one of the commands in the first process is generated, the generated command may be stored to the second storage unit. According to the information processing device 100, when the result of executing any of the commands in the first process is summarized, a summary of the result of executing the command may be stored to the second storage unit. According to the information processing device 100, by referring to the second storage unit, a command may be generated based on at least any of the first input content, the history of commands executed in the first process, and the summary of the result of executing the command. Thus, the information processing device 100 may store to the second storage unit, information useful for generating a command. The information processing device 100 may facilitate appropriate generation of a command via reference of the second storage unit.

According to the information processing device 100, it is possible to obtain the first input content representing the question content related to a failure that has occurred in the system. According to the information processing device 100, it is possible to store multiple commands including a command that may be used for the objective of investigating a failure that has occurred in the system or the objective of controlling the system. As a result, the information processing device 100 may facilitate appropriate generation of a command so that the cause of a failure occurring in the system may be easily investigated.

According to the information processing device 100, it is possible to determine the first objective corresponding to the first input content, from among multiple objectives including at least the objective of investigating a failure that has occurred in the system and the objective of controlling the system. According to the information processing device 100, among the commands, a command group that is free of a command that may cause a problem in the system when executed may be stored in the first storage unit in association with the objective of investigating a failure that has occurred in the system. According to the information processing device 100, among the commands, a command group including a command that may cause a problem in the system when executed may be stored in the first storage unit in association with the objective of controlling the system. Thus, the information processing device 100 may appropriately narrow down executable commands with consideration of security and system safety according to the first objective.

According to the information processing device 100, it is possible to use the agent and store, in the third storage unit, a command that has been executed in the first process and evaluated to have a high degree of contribution to the determined first objective. According to the information processing device 100, it is possible to use the agent and determine the second objective corresponding to the second input content. According to the information processing device 100, it is possible to identify among the commands, a second command group corresponding to the determined second objective. According to the information processing device 100, it is possible to use the agent and repeat the second process of generating and executing at least one command of the second command group and summarizing a result of executing the command until it is determined that the second object is achieved. According to the information processing device 100, in the second process, it is possible to generate one of the commands based on the history of the commands that have been executed in the first process and evaluated to have a high degree of contribution to the first objective, by referring to the third storage unit. According to the information processing device 100, in a case where the agent is used and it is determined that the second object is achieved, it is possible to generate and output the answer content corresponding to the second input content based on the summary of the result of executing the commands that have been executed in the second process.

According to the information processing device 100, an agent including a large-scale language model as a training model may be used. Thus, the information processing device 100 may make it easy to appropriately generate a command according to the first objective by utilizing the large-scale language model.

According to the information processing device 100, an agent including the first training model may be used. According to the information processing device 100, it is possible to use the agent and determine the first objective via the first training model. Thus, the information processing device 100 may use the first training model trained for an objective of determining the first objective, and may easily determine the first objective with high accuracy.

According to the information processing device 100, an agent including the second training model may be used. According to the information processing device 100, it is possible to use the agent and generate and execute at least one command of the first command group via the second training model. Thus, the information processing device 100 may use the second training model trained for the objective of generating and executing any one of the commands, and may easily generate any one of the commands with high accuracy.

According to the information processing device 100, an agent including the third training model may be used. According to the information processing device 100, it is possible to use the agent and summarize a result of executing any command via the third training model. Thus, the information processing device 100 may use the third training model trained for the objective of summarizing the result of executing any one of the commands, and with high accuracy may easily summarize the result of executing any one of the commands.

According to the information processing device 100, an agent including the fourth training model may be used. According to the information processing device 100, it is possible to use the agent and generate the answer content corresponding to the first input content via the fourth training model. Thus, the information processing device 100 may use the fourth training model trained for the objective of generating the answer content corresponding to the first input content, and may accurately generate the answer content corresponding to the first input content.

The information process method described in the present embodiment may be implemented by executing a prepared program on a computer such as a personal computer and a workstation. The program is stored on a non-transitory, computer-readable recording medium such as a hard disk, a flexible disk, a compact disc read-only memory (CD-ROM), a magneto-optical (MO) disc, and a digital versatile disc (DVD), read out from the computer-readable medium, and executed by the computer. The program may be distributed through a network such as the Internet.

According to one aspect of the present disclosure, investigation of a cause of a failure may be facilitated.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium having stored therein a program for causing a computer to execute a process, the process comprising:
using an agent that includes a training model and determining a first objective corresponding to a first input content;
identifying among a plurality of commands, a first command group corresponding to the determined first objective;
using the agent and repeatedly performing a first process of generating and executing at least one command of the identified first command group and summarizing a result of executing the generated at least one command until determining that the first objective is achieved; and
using the agent and when determining that the determined first objective is achieved, generating and outputting an answer content corresponding to the first input content, based on a summary of a result of executing each of one or more commands already executed in the first process, wherein
the repeatedly performing the first process includes generating the at least one command of the first command group, based on at least one of the first input content, a history of the one or more commands that have been executed in the first process, and the summary of the result of executing the generated at least one command of the first command group.

2. The computer-readable recording medium according to claim 1, wherein the identifying the first command group includes referring to a first storage unit that stores therein in an identifiable manner, a plurality of command groups among the plurality of commands and corresponding to a plurality of objectives, respectively.

3. The computer-readable recording medium according to claim 2, the process further comprising:
storing the generated at least one command to a second storage unit in response to generating the at least one command in the first process; and
storing the summary of the result of executing the generated at least one command, the summary of the result of executing the generated at least one command being stored to the second storage unit, in response to summarizing the result of executing the generated at least one command in the first process, wherein
the repeatedly performing the first process includes referring to the second storage unit when generating the at least one command.

4. The computer-readable recording medium according to claim 3, wherein the first input content represents a question content about a failure that has occurred in a system, and
each of the plurality of commands is a command usable in investigating the failure in the system or in controlling the system.

5. The computer-readable recording medium according to claim 4, wherein
the plurality of objectives includes at least an objective of investigating the failure that has occurred in the system and an objective of controlling the system, and
the plurality of command groups stored by the first storage unit includes a command group that is free of a command with a potential of causing a problem in the system when executed in association with an objective of investigating the failure that has occurred in the system, and includes a command group that includes a command with a potential of causing a problem in the system when executed in association with an objective of controlling the system.

6. The computer-readable recording medium according to claim 5, the process further comprising:
using the agent and storing, to a third storage unit, a command that has been executed in the first process and that is evaluated to have a high degree of contribution to the determined first objective;
using the agent and determining a second objective corresponding to a second input;
identifying among the plurality of commands, a second command group corresponding to the determined second objective;
using the agent and repeatedly performing a second process of generating and executing at least one command of the identified second command group and summarizing a result of executing the generated at least one command of the identified second command group until determining that the determined second objective is achieved; and
using the agent and when determining that the second objective is achieved, generating and outputting an answer content corresponding to the second input content, based on the summary of the result of executing each of one or more commands already executed in the second process, wherein
the repeatedly performing second process includes generating the at least one command of the second command group by referring to the third storage unit and based on at least one of the second input content, a history of the one or more commands that have been executed in the second process, a summary of a result of executing the generated at least one command of the second command group, and a history of commands that among the one or more commands that have been executed in the first process, have been evaluated to have a high degree of contribution to the first objective.

7. The computer-readable recording medium according to claim 1, wherein the training model is a large-scale language model.

8. The computer-readable storage medium according to claim 1, wherein
the agent includes a first training model, and
the determining includes using the agent and determining the first objective, via the first training model.

9. The computer-readable recording medium according to claim 1, wherein
the agent includes a second training model, and
the repeatedly performing the first process includes using the agent and generating and executing the at least one command of the first command group, via the second training model.

10. The computer-readable storage medium according to claim 1, wherein
the agent includes a third training model, and
the repeatedly performing the first process includes using the agent and summarizing a result of executing the generated at least one command, via the third training model.

11. The computer-readable storage medium according to claim 1, wherein
the agent includes a fourth training model, and
the generating and outputting the answer content includes using the agent and generating and outputting the answer content, via the fourth training model.

12. An information processing device, comprising:
a memory; and
a processor coupled to the memory, the processor configured to:
use an agent that includes a training model and determine a first objective corresponding to a first input content;
identify among a plurality of commands, a first command group corresponding to the determined first objective;
use the agent and repeatedly perform a first process of generating and executing at least one command of the identified first command group and summarizing a result of executing the generated at least one command until determining that the first objective is achieved; and
use the agent and when determining that the determined first objective is achieved, generate and output an answer content corresponding to the first input content, based on a summary of a result of executing each of one or more commands already executed in the first process, wherein
the processor, in repeatedly performing the first process, generates the at least one command of the first command group, based on at least one of the first input content, a history of the one or more commands that have been executed in the first process, and the summary of the result of executing the generated at least one command of the first command group.

13. An information processing system, comprising:
a controller;
an agent having a training model; and
a storage unit, wherein the controller is configured to:
use the agent to determine a first objective corresponding to a first input content;
identify among a plurality of commands, a first command group corresponding to the determined first objective;
use the agent to repeatedly perform a first process of generating at least one command of the identified first command group, cumulatively storing the generated at least one command in the storage unit, executing the generated at least one command, summarizing a result of executing the generated at least one command, and cumulatively storing a summary of the result of executing the generated at least one command in the storage unit until determining that the determined first object is achieved; and
use the agent to generate and output an answer content corresponding to the first input content, when determining that the first objective is achieved, the answer content being generated based on a summary cumulatively stored in the storage unit and summarizing a result of executing each of the one or more commands already executed in the first process, wherein
the controller generates the at least one command, based on at least one of the first input content, a history of the one or more commands that have been executed in the first process and cumulatively stored in the storage unit, and a summary cumulatively stored in the storage unit and summarizing a result of executing each of one or more commands that have been executed in the first process.
